(19) United States
(12) Patent Application Publication
(10) Pub. No.: US 2015/0309433 A1
(43) Pub. Date: Oct. 29, 2015

(54) ELECTROSTATIC CHARGE IMAGE DEVELOPING TONER

(71) Applicant: Konica Minolta Inc., Tokyo (JP)

(72) Inventors: Ikuko SAKURADA, Tokyo (JP); Satoshi Uchino, Tokyo (JP); Yasuko Uchino, Tokyo (JP); Shinya Obara, Tokyo (JP); Futoshi Kadonome, Tokyo (JP); Hiroyuki Kozuru, Otsuki-shi (JP)

(21) Appl. No.: 14/682,708

(22) Filed: Apr. 9, 2015

(30) Foreign Application Priority Data
Apr. 28, 2014 (JP) 2014-092381

(51) Int. Cl. G03G 9/087; G03G 9/08

(52) U.S. Cl. CPC G03G 9/08711; G03G 9/0819

(57) ABSTRACT

An electrostatic charge image developing toner includes: toner matrix particles containing a binder resin; and an external additive added to the toner matrix particles, wherein the external additive includes joined particles each including a secondary particle including a plurality of spherical primary particles joined together, the joined particles include at least particles with a secondary particle size d2 in the range of 70 nm to 400 nm, and particles with a ratio d2/d1 in the range of 1.6 to 4.2 make up at least 50% by number of the particles with a secondary particle size d2 in the range of 70 nm to 400 nm, wherein d1 is the diameter of primary particles in the joined particle, and d2 is the secondary particle size.

The entire disclosure of Japanese Patent Application No. 2014-092381 filed on Apr. 28, 2014 including description, claims, drawings, and abstract are incorporated herein by reference in its entirety.

### BACKGROUND OF THE INVENTION

1. Field of the Invention

The present invention relates to an electrostatic charge image developing toner for use in forming electrophotographic images.

2. Description of the Related Art

Electrophotographic image forming apparatuses such as printers and multifunction printers are increasing in speed and image quality. An increase in speed leads to an increase in mechanical stress on electrostatic charge image developing toners (hereinafter also simply referred to as “toners”) in a developing device. Stable output of high-quality images is also required in such high-speed situations.

Toners that are less likely to undergo durability degradation need to be used so that high-quality images can be stably output from a high-speed image forming apparatus.

Toners generally include toner matrix particles and a particulate external additive that is added on the surface of each toner matrix particle and made of an inorganic fine powder or a resin. The term “durability degradation” means that when undergoing mechanical stress for a long time in a developing device, a toner and a carrier mingle together so that external additive particles transfer to the carrier or when undergoing mechanical stress, external additive particles are buried in toner matrix particles, so that the toner matrix particles undergo changes in electrostatic properties.

To suppress the degradation of the toner durability, for example, small-size external additive particles and large-size external additive particles are used together so that the spacer effect of the large-size external additive particles can prevent the small-size external additive particles from being buried in toner matrix particles (see, for example, JP 2009-186512 A).

When only large-size external additive particles are used, however, a problem occurs in which the large-size external additive particles have weak adhesion to toner matrix particles and thus cannot be prevented from transferring to the carrier.

Also to suppress the degradation of the toner durability, for example, irregularly-shaped external additive particles with higher adhesion to toner matrix particles are used so that their spacer effect can be exerted for a long time to prevent, for a long time, small-size external additive particles from being buried in the toner matrix particles (see, for example, JP 2012-128195 A).

However, the irregularly-shaped external additive particles disclosed in if 2012-128195 A have a problem in that they have a high water content and thus cannot provide charge stability in a high-temperature, high-humidity environment because they are produced by sol-gel method.

### SUMMARY OF THE INVENTION

The present invention has been accomplished in view of the above circumstances, and an object thereof is to provide an electrostatic charge image developing toner that is significantly less likely to undergo durability degradation and can provide high charge stability in a high-temperature, high-humidity environment.

To achieve the abovementioned object, according to an aspect, an electrostatic charge image developing toner reflecting one aspect of the present invention comprises: toner matrix particles containing a binder resin; and an external additive added to the toner matrix particles, wherein the external additive includes joined particles each including a secondary particle including a plurality of spherical primary particles joined together, the joined particles include at least particles with a secondary particle size d2 in the range of 70 nm to 400 nm, and particles with a ratio d2/d1 in the range of 1.6 to 4.2 make up at least 50% by number of the particles with a secondary particle size d2 in the range of 70 nm to 400 nm, wherein d1 is the diameter of primary particles in the joined particle, and d2 is the secondary particle size.

In the electrostatic charge image developing toner according to an aspect of the present invention, the binder resin preferably has an acid value of 2 KOHmg/g to 30 KOHmg/g.

In the electrostatic charge image developing toner according to an aspect of the present invention, the binder resin constituting the toner matrix particles preferably includes a vinyl resin.

In the electrostatic charge image developing toner according to an aspect of the present invention, the binder resin constituting the toner matrix particles preferably includes a vinyl resin and a polyester resin.

In the electrostatic charge image developing toner according to an aspect of the present invention, the binder resin constituting the toner matrix particles preferably includes a vinyl-modified polyester resin including a vinyl polymer segment and a polyester segment bonded together.

In the electrostatic charge image developing toner according to an aspect of the present invention, the joined particles preferably include particles having a secondary particle size d2 in the range of 70 nm to 400 nm and a ratio d2/d1 of secondary particle size d2 to primary particle diameter d1 in the range of 1.6 to 4.2, wherein the primary particle diameter d1 is preferably in the range of 30 nm to 200 nm.

In the electrostatic charge image developing toner according to an aspect of the present invention, the joined particles are preferably silica particles obtained by sol-gel method.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIGS. 1A, 1B, and 1C are schematic diagrams for illustrating joined particles in an electrostatic charge image developing toner according to an embodiment of the present invention.

### DESCRIPTION OF THE PREFERRED EMBODIMENTS

Hereinafter, an embodiment of the present invention will be described with reference to the drawings. However, the scope of the invention is not limited to the illustrated examples.

[Toner]

The toner according to an embodiment of the present invention includes binder resin-containing toner matrix particles (hereinafter also referred to as “tone particles”) and an external additive added to the toner particles.

The external additive includes joined particles each including a plurality of spherical primary particles joined together.

[Joined Particles]

The joined particles each include two or more spherical primary particles joined together, in which the primary particles maintain their own particulate shape, and their spherical surfaces form bumps and dents.

More specifically, the joined particle is defined as follows. Arbitrarily selected two primary particles are visually observed in a photograph taken at a magnification of 30,000 times with a scanning electron microscope. When the two primary particles are in surface contact with each other and specifically when the two primary particles are joined together in such a way that 55% to 95% of the circular area of each primary particle remains, the particle including the two joined primary particles is determined to be the joined particle. The joined particle with such features can maintain its shape even when vibrations are applied thereto. The term “joined particle” is not intended to include a particle composed of a plurality of primary particles in single-point contact with each other or flat-shaped particle with no bumps or dents formed by special surfaces.

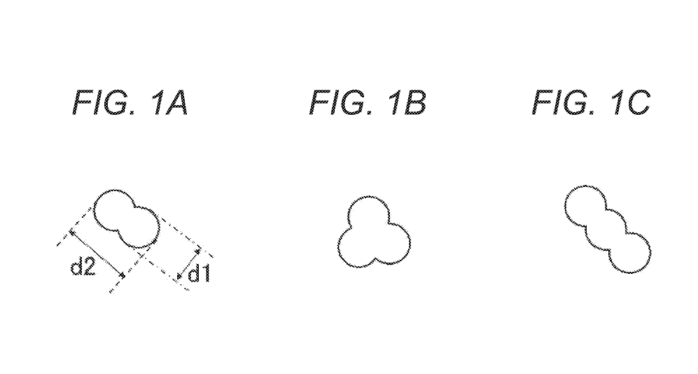

More specifically, examples of the joined particle include a two-sphere particle in which two primary particles are in surface contact with each other and joined as shown in FIG. 1A; a triangular particle in which three primary particles are circularly arranged, in surface contact with one another, and joined as shown in FIG. 1B; and a chain-like particle in which three primary particles are arranged in series, in surface contact with each other, and joined as shown in FIG. 1C.

The joined particle has a secondary particle size d2, which is the maximum distance between two arbitrary points on the periphery of the joined particle. The joined particle has a primary particle size d1, which is the diameter of the primary particles constituting the joined particle. The primary particle size d1 and the secondary particle size d2 of the joined particle can be measured in a photograph taken at a magnification of 30,000 times with a scanning electron microscope.

In an embodiment of the present invention, the joined particles include at least particles with a secondary particle size d2 in the range of 70 nm to 400 nm (hereinafter also referred to as “specific-size joined particles (A)”). Joined particles with a redo of secondary particle size d2 to primary particle size d1 (the diameter of the primary particles constituting the joined particles) in the range of 1.6 to 4.2 make up 50% by number to 100% by number of the specific-size joined parsicles) (hereinafter, such a ratio is also referred to as a “size ratio d2/d1,” and the joined particles with a size ratio d2/d1 in the range of 1.6 to 4.2 are also referred to as “specific-shape joined particles (a)”).

When the content of she specific-shape joined particles (a) in the specific-size joined particles (A) is 50% by number or more, she joined particles have high shape uniformity and thus can be uniformly attached to the toner particles. This makes it possible to highly suppress the degradation of the toner durability and to suppress the transfer of the specific-shape joined particles (a) to the carrier, so that the associated reduction in electrostatic charge amount can be kept sufficiently small.

Specifically, the content of the specific-shape joined particles (a) in the specific-size joined particles (A) is determined as described below.

First, a photograph is taken at a magnification of 30,000 times with a scanning electron microscope. In the photograph, specific-size joined particles (A) with a secondary particle size in the range of 70 nm to 400 nm are selected, and a measurement region is selected in which the total number of the specific-size joined particles (A) is about 100 to about 200. Next, the number P1 of the specific-size joined particles (A) in the measurement region is counted. In the measurement region, all the specific-size joined particles (A) are subjected to the measurement of the diameter of each primary particle constituting each specific-size joined particle (A), and the average of the measurements is used as the primary particle size d1 to calculate the size ratio d2/d1. Particles with a size ratio d2/d1 in she range of 1.6 to 4.2 are identified as the specific-shape joined particles (a), and the number P2 of them is counted. The content of the specific-shape particles (a) in the specific-size particles (A) is calculated from these measurement results using the formula P2/P1×100.

The specific-size joined particles (A) each have a secondary particle size d2 of 70 rim to 400 nm. When the toner contains joined particles with a secondary particle size d2 of 70 nm or more, the external additive can be effectively prevented from being buried in the toner particles. The joined particles with a secondary particle size d2 of 400 nm or less can be effectively prevented from transferring to the carrier or the photoreceptor.

The specific-shape joined particles (a) have a size ratio d2/d1 in the range of 1.6 to 4.2.

The joined particles with a size ratio d2/d1 of 1.6 or more can have sufficient adhesion to the toner particles. The joined particles with a size ratio d2/d1 of 4.2 or less can impart high charge stability to the toner even in a high-temperature, high-humidity environment because the water content of the joined particles can be kept low.

The specific-shape joined particles (a) preferably have a primary particle size d1 in the range of 30 nm to 200 nm, wherein the primary particle size d1 is the average of the diameters of the respective primary particles constituting the specific-shape joined particles (a).

When the specific-shape joined particles (a) have a primary particle size d1 of 30 nm or more, the external additive can be reliably prevented from being buried in the toner particles. On the other hand, the specific-shape joined particles (a) with a primary particle size d1 of 200 nm or less can have sufficient adhesion to the toner particles.

The number of the primary particles in the specific-shape joined particle (a) is preferably, for example, two or three.

In the toner according to an embodiment of the present invention, the content of the specific-size joined particles (A), which contain 50% by number or more of the specific-shape joined particles (a), is preferably from 0.3 to 3 parts by mass, more preferably from 0.5 to 1.2 parts by mass, based on 100 parts by mass of the toner matrix particles.

When the content of the specific-size joined particles (A) falls within the range, the effect of highly suppressing durability degradation can be reliably obtained.

To form the toner according to an embodiment of the present invention, the joined particles described above are added as an external additive to the toner particles, and the specific-size joined particles (A) containing 50% by number or more of the specific-shape joined particles are added as the external additive to the on particles. These features of the toner according to an embodiment of the present invention highly suppress durability degradation and provide high charge stability in a high-temperature, high-humidity environment.

More specifically, the addition of the specific-size joined particles (A) produces a spacer effect, and their unique shape provides increased contact points with the toner particles, so that the joined particles can have sufficient adhesion to the toner particles and suppress the degradation of the toner durability. In addition, the specific-shape joined particles (a) make up 50% by number or more of the specific-size joined particles (A) which means that variations in the particle size distribution of the specific-size joined particles (A) are small. Therefore, the joined particles can be uniformly attached to the toner particles, so that the degradation of the toner durability can be highly suppressed. In addition, since variations in the particle size distribution of the specific-size joined particles (A) are small, the water content can be kept low, so that high charge stability can be imparted to the toner even in a high-temperature, high humidity environment.

[Method for Producing Joined Particles]

The joined particles in the toner according to an embodiment of the present invention are preferably silica particles obtained by sol-gel method.

More specifically, the joined particles are produced as follows. First, tetramethoxysilane is added to pure water to form a TMOS hydrolysis liquid. The TMOS hydrolysis liquid is added at a specific constant rate to a mixed solution of water and ethylenediamine. An alkali catalyst is then added as appropriate to the mixture while the pH is controlled. At regular time intervals, the TMOS hydrolysis liquid is further added at the specific constant rate, which is followed by hydrolysis and condensation, so that a dispersion [1] of hydrophilic spherical silica fine particles in a mixed medium is obtained.

Subsequently, methyltrimethoxysilane is added dropwise to the dispersion [1] of hydrophilic spherical silica fine particles in a mixed medium and then allowed to react by heating to make the surface of the spherical silica fine particles hydrophobic, so that a dispersion [2] of hydrophobic spherical silica fine particles in a mixed medium is obtained.

The dispersion [2] of hydrophobic spherical silica fine particles in a mixed medium was then heated so that water is removed by distillation. Subsequently, while methyl isobutyl ketone is added to the dispersion, a mixture of methanol, water, and methyl isobutyl ketone is simultaneously removed by distillation until the dispersion reaches 115° C. Octyltrimethoxysilane is added to the resulting methyl isobutyl ketone dispersion at room temperature. The dispersion is then allowed to react by heating so that the silica fine particles in the dispersion are alkylated. Subsequently, the solvent is removed by distillation from the dispersion, so that specific-size joined particles containing specific-shape joined particles are obtained.

The content of the specific-shape joined particles in the resulting specific-size joined particles can be controlled by changing the amount of the addition of ethylenediamine and the rate at which the TMOS hydrolysis solution is added.

[Other External Additives]

The toner according to an embodiment of the present invention, which contains the joined particles as an external additive, may contain other external additives for improving the ability of the toner to be electrostatically charged or the fluidity of the toner. Examples of other external additives include inorganic oxide fine particles such as silica fine particles, alumina fine particles, and titanium oxide fine particles; fine particles of a complex oxide of any of these oxides; and organic fine particles.

Silica fine particles with a number average particle size of about 5 to about 50 nm are preferably used to improve the fluidity of the toner and the ability of the toner to be electrostatically charged. Spherical silica particles with a number average particle size of 80 to 500 nm produced by sol-gel process may be used to improve the cleanability. The use of such silica particles in combination with specific lubricant particles according to an embodiment of the present invention can further improve the cleanability. Such silica fine particles are preferably surface-treated with a silane coupling agent for reducing the humidity dependence of the ability of the toner to be electrostatically charged.

Calcium titanate, strontium titanate, or the like is preferably used for complex oxide fine particles with a higher ability to grind the photoreceptor.

The organic fine particles may be spherical organic fine particles with a number average primary particle size of about 10 to about 2,000 nm. Specifically, organic fine particles made of a homopolymer of styrene or methyl methacrylate or a copolymer thereof may be used. Any combination of these external additives may also be used.

Concerning the content of the external additives, the total content of the joined particles and other external additives is preferably from 2.0 to 8.0 parts by mass based on 100 parts by mass of the toner matrix particles.

The toner particles, which include at least the binder resin, may optionally contain internal additives such as a colorant, a releasing agent, and a charge control agent.

[Binder Resin]

The binder resin used to form the toner particles may be any of various known binder resins. The binder resin may be, for example, a vinyl resin such as a styrene resin, an acrylic resin, a styrene acrylic resin, or an olefin resin, a polyester resin, a vinyl-modified polyester resin including a vinyl polymer segment and a polyester segment bonded together, a silicone resin, an amide resin, an epoxy resin, or the like.

These resins may be used singly or in combination of two or more.

The binder resin preferably includes a vinyl resin alone, a combination of a vinyl resin and a polyester resin, or a vinyl-modified polyester resin.

The binder resin preferably has an acid value of 2 KOHmg/g to 30 KOHmg/g.

When the acid value of the binder resin falls within the range, a reduction in charge amount can be prevented, which would otherwise be caused by the adsorption of water to the surface of the toner particles, and the surface of the toner particles can be made less hydrophilic, so that the adhesion to the hydrophobic joined particles can be made very high.

The acid value of the binder resin is defined as the mass (mg) of KOH required to completely neutralize 1 g of the binder resin, which can be measured by the method according to JIS K 0070 (1992).

[Styrene Acrylic Resin]

The styrene acrylic resin is made from a styrene monomer and a (meth)acrylic ester monomer.

Examples of the styrene monomer include styrene, o-methylstyrene, m-methylstyrene, p-methylstyrene, α-methylstyrene, p-phenylstyrene, p-ethylstyrene, p-n-butylstyrene, p-tert-butylstyrene, p-n-hexylstyrene, p-n-octylstyrene, p-n-nonylstyrene, p-n-decylstyrene, p-n-dodecylstyrene, 2,4-dimethylstyrene, and derivatives thereof.

These styrene monomers may be used singly or in combination of two or more.

Examples of the (meth)acrylic ester monomer include methyl acrylate, ethyl acrylate, n-propyl acrylate, isopropyl acrylate, n-butyl acrylate, isobutyl acrylate, tert-butyl acrylate, n-octyl acrylate, 2-ethylhexyl acrylate, stearyl acrylate, lauryl acrylate, phenyl acrylate, methyl methacrylate, ethyl methacrylate, n-propyl methacrylate, isopropyl methacrylate, n-butyl methacrylate, isobutyl methacrylate, tert-butyl methacrylate, n-octyl methacrylate, 2-ethylhexyl methacrylate, stearyl methacrylate, lauryl methacrylate, phenyl methacrylate, diethylaminoethyl methacrylate, dimethylaminoethyl methacrylate, etc.

These (meth)acrylic ester monomers may be used singly or in combination of two or more.

The styrene monomer and/or the (meth)acrylic ester monomer may also be used together with any of the following vinyl monomers:

Olefins such as ethylene, propylene, and isobutylene;

Vinyl esters such as vinyl propionate, vinyl acetate, and vinyl benzoate;

Vinyl ethers such as vinyl methyl ether and vinyl ethyl ether;

Vinyl ketones such as vinyl methyl ketone, vinyl ethyl ketone, and vinyl hexyl ketone;

N-vinyl compounds such as N-vinylcarbazole, N-vinylindole, and N-vinylpyrrolidone; and

Others such as vinyl compounds such as butadiene, vinylnaphthalene, and vinylpyridine, acrylic or methacrylic acid derivatives such as acrylonitrile, methacrylonitrile, acrylamide, and methacrylamide, and maleic anhydride.

The styrene monomer and/or the (meth)acrylic ester monomer may be used together with any of the following polyfunctional vinyl monomers to form a binder resin with a crosslinked structure.

Polyfunctional vinyl monomers such as divinylbenzene, ethylene glycol dimethacrylate, ethylene glycol diacrylate, diethylene glycol dimethacrylate, diethylene glycol diacrylate, triethylene glycol dimethacrylate, triethylene glycol diacrylate, neopentyl glycol dimethacrylate, neopentyl glycol diacrylate, hexylene glycol dimethacrylate, hexylene glycol diacrylate, and dimethacrylates and trimethacrylates of a tri- or polyhydric alcohol such as pentaerythritol or trimethylolpropane.

The content (copolymerization ratio) of the polyfunctional vinyl monomer in all the polymerizable monomers used to form the styrene acrylic resin is generally from 0.001 to 5% by mass, preferably from 0.003 to 2% by mass.

When the polyfunctional vinyl monomer is used, a gel component insoluble in tetrahydrofuran is formed in the styrene acrylic resin. Such a gel component preferably makes up 40% by mass or less, more preferably 20% by mass or less of the whole of the styrene acrylic resin.

The styrene monomer and/or the (meth)acrylic ester monomer may also be used together with any of the following polymerizable monomers having an ionic leaving group such as a carboxy or phosphate group.

Carboxy group-containing polymerizable monomers such as acrylic acid, methacrylic acid, maleic acid, itaconic acid, cinnamic acid, fumaric acid, monoalkyl maleate, and monoalkyl itaconate;

Sulfonic acid group-containing polymerizable monomers such as styrenesulfonic acid, allyl sulfosuccinate, and 2-acrylamido-2-methylpropanesulfonic acid; and

Phosphate group-containing polymerizable monomers such as acid phosphoxyethyl methacrylate and 3-chloro-2-acid phosphoxypropyl methacrylate.

The styrene acrylic resin may be synthesized using any of various known methods.

The styrene acrylic resin preferably has a weight average molecular weight (Mw) of 2,000 to 1,000,000 as measured by gel permeation chromatography (GPC). Its number average molecular weight (Mn) is preferably from 1,000 to 100,000. The molecular weight distribution (Mw/Mn) is preferably from 1.5 to 100, more preferably from 1.8 to 70.

When the weight average molecular weight (Mw) number average molecular weight (Mn), and molecular weight distribution (Mw/Mn) of the styrene acrylic resin fall within these ranges, a hot offset phenomenon can be effectively prevented during heat fixing.

The molecular weight is measured by GPC as follows. Specifically, a system HLC-8220 (manufactured by Tosoh Corporation) and columns TSK guard column+TSKgel Super HZM-M×3 (manufactured by Tosoh Corporation) are used, in which tetrahydrofuran (THF) as a carrier solvent is allowed to flow at a rate of 0.2 ml/min while the column temperature is kept at 40° C. The measurement sample (styrene acrylic resin) is dissolved at a concentration of 1 mg/ml in tetrahydrofuran under dissolution conditions using an ultrasonic disperser at room temperature for 5-minute treatment. The solution is then filtered with a membrane filter with a pore size of 0.2 μm to give a sample solution. Ten μL of the sample solution is injected together with the carrier solvent into the system. The detection is performed using a refractive index detector (RI detector). The molecular weight distribution of the measurement sample is calculated using a calibration curve measured with standard monodisperse polystyrene particles. The standard polystyrene samples used in the measurement of the calibration curve have molecular weights of 6×10², 2.1×10³, 4×10³, 1.75×10⁴, 5.1×10⁴, 1.1×10⁵, 3.9×10⁵, 8.6×10⁵, 2×10⁶, and 4.48×10⁶, respectively, which are manufactured by Pressure Chemical Company. At least 10 standard polystyrene samples are measured when the calibration curve is prepared. The detection is performed using a refractive index detector.

The styrene acrylic resin preferably has a glass transition point of 30 to 70° C.

The styrene acrylic resin with a glass transition point in this range can provide good fixing properties.

The glass transition point of the styrene acrylic resin is the value measured by the method according to ASTM (American Society for Testing and Materials' Standard) D341.8-82. (DSC method) using the styrene acrylic resin as the measurement sample.

[Polyester Resin]

The polyester resin is a product synthesized by polycondensation reaction of a polycarboxylic acid material and a polyalcohol material as raw materials in the presence of a suitable catalyst.

Examples of the polycarboxylic acid material that may be used include polycarboxylic acids and alkyl esters thereof, acid anhydrides and acid chlorides thereof. Examples of the polyalcohol material that may be used include polyalcohols and ester compounds thereof, and hydroxycarboxylic acids.

Examples of polycarboxylic acids include dicarboxylic acids such as oxalic acid, succinic acid, maleic acid, adipic acid, β-methyladipic acid, azelaic acid, sebacic acid, nonanedicarboxylic acid, decanedicarboxylic acid, undecanedicarboxylic acid, dodecanedicarboxylic acid, fumaric acid, citraconic acid, diglycolic acid, cyclohexane-3,5-diene-1,2-dicarboxylic acid, malic acid, citric acid, hexahydroterephthalic acid, malonic acid, pimellic acid, tartaric acid, mucic acid, phthalic acid, isophthalic acid, terephthalic acid, tetrachlorophthalic acid, chlorophthalic acid, nitrophthalic acid, p-carboxyphenylacetic acid, p-phenylenediacetic acid, m-phenylenediglycolic acid, p-phenylenediglycolic acid, o-phenylenediglycolic acid, diphenylacetic acid, diphenyl-p,p′-dicarboxylic acid, naphthalene-1,4-dicarboxylic acid, naphthalene-1,5-dicarboxylic acid, naphthalene-2,6-dicarboxylic acid, anthracenedicarboxylic acid, and dodecenylsuccinic acid; and tri- or polycarboxylic acids such as trimellitic acid, pyromellitic acid, naphthalenetricarboxylic acid, napthalenetetracarboxylic acid pyrenetricarboxylic acid, and pyrenetetracarboxylic acid.

The polycarboxylic acid materials may be used singly or in combination of two or more.

Examples of polyalcohols include dihydric alcohols such as ethylene glycol, propylene glycol, butanediol, diethylene glycol, hexanediol, cyclohexanediol, octanediol, decanediol, dodecanediol, ethylene oxide adducts of bisphenol A, and propylene oxide adducts of bisphenol A; and tri- or polyols such as glycerin, pentaerythritol, hexamethylolmelamine, hexaethylolmelamine, tetramethylolbenzoguanamine, and tetraethylolbenzoquanamine.

The polyalcohol materials may be used singly or in combination of two or more.

The polyester resin may be produced using any common polymerization method for polyester, which include allowing the polycarboxylic acid material and the polyalcohol material to react in the presence of a catalyst. Preferably, for example, direct polycondensation or transesterification is selectively used for the production depending on the monomer type.

The polymerization may be performed at a temperature between 180° C. and 230° C., and if necessary, the pressure in the reaction system may be reduced so that water and the alcohol produced during the condensation can be removed while the reaction is performed.

If the monomer is not soluble or compatible at the reaction temperature, a high-boiling-point solvent may be added as a solubilizinq agent to dissolve the monomer. The polycondensation reaction should be performed while the solubilizing agent is removed by distillation. When a less-compatible monomer is used for copolymerization reaction, the less-compatible monomer and the acid or alcohol to be polycondensed therewith should be condensed in advance, and then the product and the main material should be polycondensed together.

Examples of the catalyst that may be used in the production of the polyester resin include compounds of alkali metals such as sodium and lithium; compounds of alkaline-earth metals such as magnesium and calcium; compounds of metals such as zinc, manganese, antimony, titanium, tin, zirconium, and germanium; phosphorous acid compounds; phosphoric acid compounds; and amine compounds.

More specifically, examples include sodium acetate, sodium carbonate, lithium acetate, lithium carbonate, calcium acetate, calcium stearate, magnesium acetate, zinc acetate, zinc stearate, zinc naphthenate, zinc chloride, manganese acetate, manganese naphthenate, titanium tetraethoxide, titanium tetrapropoxide, titanium tetraisopropoxide, titanium tetrabutoxide, antimony trioxide, triphenylantimony, tributylantimony, tin formate, tin oxalate, tetraphenyltin, dibutyltin dichloride, dibutyltin oxide, diphenyltin oxide, zirconium tetrabutoxide, zirconium naphthenate, zirconium carbonate, zirconium acetate, zirconium stearate, zirconium octoate, germanium oxide, triphenyl phosphite, tris(2,4-di-tert-butylphenyl)phosphite, ethyltriphenylphosphonium bromide, triethylamine, and triphenylamine.

The polycarboxylic acid material and the polyalcohol material are preferably used in such a ratio that the equivalent ratio [OH]/[COOH] of the hydroxyl group [OH] of the polyalcohol material to the carboxyl group [COOH] of the polycarboxylic acid material is from 1.5/1 to 1/1.5, more preferably from 1.2/1 to 1/1.2.

The polyester resin preferably has a weight average molecular weight (Mw) of 5,000 to 100,000, more preferably 5,000 to 50,000 as measured by gel permeation chromatography (GPC).

The molecular weight is measured by GPC as follows. Specifically, a system HILO-8220 (manufactured by Tosoh Corporation) and columns TSK guard column+TSKgel Super HZM-M×3 (manufactured by Tosoh Corporation) are used, in which tetrahydrofuran (THF) as a carrier solvent is allowed to flow at a rate of 0.2 ml/min while the column temperature is kept at 40° C. The measurement sample (polyester resin) is dissolved at a concentration of 1 mg/ml in tetrahydrofuran under dissolution conditions using an ultrasonic disperser at room temperature for 5-minute treatment. The solution is then filtered with a membrane filter with a pore size of 0.2 μm to give a sample solution. Ten μL of the sample solution is injected together with the carrier solvent into the system. The detection is performed using a refractive index detector (RI detector). The molecular weight distribution of the measurement sample is calculated using a calibration curve measured with standard monodisperse polystyrene particles. The standard polystyrene samples used in the measurement of the calibration curve have molecular weights of 6×10², 2.1×10³, 4×10³, 1.75×10⁴, 5.1×10⁴, 1.1×10⁵, 3.9×10⁵, 8.6×10⁵, 2×10⁶, and 4.48×10⁶, respectively, which are manufactured by Pressure Chemical Company. At least 10 standard polystyrene samples are measured when the calibration curve is prepared. The detection is performed using a refractive index detector.

The polyester resin preferably has a glass transition point of 40 to 90° C., more preferably 45 to 85° C.

The glass transition point of the polyester resin is the value measured by the method according to ASTM (American Society for Testing and Materials' Standard) D3418-82 (DSC method) using the polyester resin as the measurement sample.

[Vinyl-Modified Polyester Resin]

The vinyl-modified polyester resin includes a copolymer including a vinyl polymer segment and a polyester segment bonded together.

The vinyl-modified polyester resin may have a block copolymer structure in which the vinyl polymer segment is bonded to the end of the polyester segment or have a graft copolymer structure in which a branch structure of the vinyl polymer segment is formed on the polyester segment.

[Vinyl Polymer Segment]

The vinyl polymer segment is made from, for example, a vinyl monomer such as a styrene monomer or a (meth)acrylic ester monomer.

Examples of the styrene monomer and the (meth)acrylic ester monomer that may be used to form the vinyl polymer segment include those of the styrene monomer and the (meth)acrylic ester monomer listed above that may be used to form the styrene acrylic resin.

The vinyl polymer segment alone preferably has a glass transition point of 35 to 80° C., more preferably 40 to 60° C.

The glass transition point of the vinyl polymer segment alone can be measured in the same way as described above, except that the vinyl polymer segment is used as the measurement sample.

The vinyl polymer segment alone preferably has a weight average molecular weight (Mw) of 2,000 to 100,000 as calculated from the molecular weight distribution measured by gel permeation chromatography (GPC).

The molecular weight distribution of the vinyl polymer segment is measured by GPC in the same way as described above, except that the vinyl polymer segment is used as the measurement sample.

[Polyester Segment]

The polyester segment is made from a polycarboxylic acid material and a polyalcohol material.

Examples of the polycarboxylic acid material and the polyalcohol material that may be used to form the polyester segment include those of the polycarboxylic acid material and the polyalcohol material listed above that may be used to form the polyester resin.

The polyester segment alone preferably has a glass transition point of 40 to 70° C., more preferably 50 to 65° C.

The glass transition point of the polyester segment alone can be measured in the same way as described above, except that the polyester segment is used as the measurement sample.

The polyester segment alone preferably has a weight average molecular weight (Mw) of 1,500 to 60,000 as calculated from the molecular weight distribution measured by gel permeation chromatography (GPC).

The molecular weight distribution of the polyester segment is measured by GPC in the same way as described above, except that the polyester segment is used as the measurement sample.

[Method for Producing Vinyl-Modified Polyester Resin]

The vinyl-modified polyester resin can be produced by coupling the polyester segment and the vinyl polymer segment through a double-reactive monomer. Specifically, the vinyl-modified polyester resin can be produced by performing polycondensation reaction in the presence of a polycarboxylic acid material and a polyalcohol material at least one of before, during, and after the step of performing addition polymerization of a vinyl monomer.

Specifically, existing common schemes may be used. Typical methods include the following owing three methods. (1) A method that includes performing an addition polymerization reaction of a vinyl monomer to form a vinyl polymer segment, then performing a polycondensation reaction of a polycarboxylic acid material and a polyalcohol material to form a polyester segment, adding, as needed, a tri- or polyvalent vinyl monomer as a crosslinking agent to the reaction system, and allowing the polycondensation reaction to further proceed. (2) A method that includes performing a polycondensation reaction of a polycarboxylic acid material and a polyalcohol material to form a polyester segment, then performing an addition polymerization reaction of a vinyl monomer to form a vinyl polymer segment, then adding, as needed, a tri- or polyvalent vinyl monomer as a crosslinking agent to the reaction system, and allowing the polycondensation reaction to further proceed under suitable temperature conditions. (3) A method that includes performing in parallel an addition polymerization reaction of a vinyl monomer under suitable temperature conditions to form a vinyl polymer segment and a polycondensation reaction of a polycarboxylic acid material and a polyalcohol material to form a polyester segment, completing the addition polymerization reaction, then adding, as needed, a tri- or polyvalent vinyl monomer as a crosslinking agent to the reaction system, and allowing the polycondensation reaction to further proceed under suitable temperature conditions.

The double-reactive monomer is added together with the polycarboxylic acid material, the polyalcohol material, and/or the vinyl monomer.

The double-reactive monomer may be a compound having an ethylenic unsaturated bond and at least one functional group selected from the group consisting of a hydroxyl group, a carboxy group, an epoxy group, a primary amino group, and a secondary amino group in the molecule. The double-reactive monomer is preferably a compound having an ethylenic unsaturated bond and a hydroxyl group and/or a carboxy group, more preferably a compound having an ethylenic unsaturated bond and a carboxy group, in other words, a vinyl carboxylic acid.

More specifically, examples of the double-reactive monomer include carboxy group-conning vinyl compounds such as acrylic acid, methacrylic acid, fumaric acid, and maleic acid; and carboxylic anhydrides such as maleic anhydride.

The double-reactive monomer is preferably used in an amount of 0.1 to 5.0% by mass, more preferably 0.5 to 3.0% by mass, based on 100% by mass of the total amount of the monomers used to form. the vinyl-modified polyester resin.

The addition polymerization reaction may be performed using a conventional method, for example, in the presence of a radical polymerization initiator, a crosslinking agent, and other materials in an organic solvent or without any solvent. The temperature conditions are preferably from 110 to 200° C., more preferably from 140 to 180° C. Examples of the radical polymerization initiator include dialkyl peroxide, dibutyl peroxide, and butyl peroxy-2-ethylhexyl monocarboxylate. These may be used singly or in combination of two or more.

The polycondensation reaction may be performed, for example, under the temperature conditions of 180 to 250° C. in an inert gas atmosphere, preferably in the presence of an esterification catalyst, a polymerization inhibitor, and other materials. Examples of the esterification catalyst include dibutyltin oxide, titanium compounds, and tin (II) compounds with no Sn—C bond, such as tin octoate. These may be used singly or in any combination.

The softening point of the binder resin is preferably from 80 to 120° C., more preferably from 90 to 110° C., in order to impart low-temperature fixability to the toner.

The softening point of the binder resin can be measured with the flow tester shown below.

More specifically, 1.1 g of the sample (binder resin) is added to a petri dish and flattened in an environment at 20° C. and 50% RH. After allowed to stand for 12 hours or more, the sample is pressed with a force of 3,820 kg/cm² for 30 seconds using a shaper SSP-10A (manufactured by SHIMADZU CORPORATION), so that a cylindrical shaped sample with a diameter of 1 cm is obtained. Subsequently, using a flow tester CFT-500D (manufactured by SHIMADZU CORPORATION), the shaped sample is extruded by means of a 1-cm-diameter piston through a hole (1 mm diameter×1 mm) of a cylindrical die under the conditions of a load of 196 N (20 kgf), a starting temperature of 60° C., a preheating time of 300 seconds, and a rate of temperature rise of 6° C./minute in an environment at 24° C. and 50% RH after the preheating is completed. The softening point is defined as the offset temperature T_{offset} measured with an offset value of 5 mm by the melting temperature measurement in the temperature rise method.

[Colorant]

The toner particles may contain a colorant. In this case, commonly known dyes and pigments may be used as the colorant.

The colorant for a black toner may be any of various known materials such as carbon black such as furnace black or channel black, magnetic materials such as magnetite and ferrite, dyes, and nonmagnetic iron oxide-containing inorganic pigments.

The colorant for a color toner may be any of known materials such as dyes and organic pigments. Examples of organic pigments include C.I. Pigment Red 5, C.I. Pigment Red 48:1, C.I. Pigment Red 53:1, C.I. Pigment Red 57:1, C.I. Pigment Red 81:4, C.I. Pigment Red 122, C.I. Pigment Red 139, C.I. Pigment Red 144, C.I. Pigment Red 149, C.I. Pigment Red 166, C.I. Pigment Red 177, C.I. Pigment Red 178, C.I. Pigment Red 222, C.I. Pigment Red 238, C.I. Pigment Red 269, C.I. Pigment Yellow 14, C.I. Pigment Yellow 17, C.I. Pigment Yellow 74, C.I. Pigment Yellow 93, C.I. Pigment Yellow 94, C.I. Pigment Yellow 138, C.I. Pigment Yellow 155, C.I. Pigment Yellow 180, C.I. Pigment Yellow 185, C.I. Pigment Orange 31, C.I. Pigment Orange 43, C.I. Pigment Blue 15:3, C.I. Pigment Blue 60, and C.I. Pigment Blue 76. Examples of dyes include C.I. Solvent Red 1, C.I. Solvent Red 49, C.I. Solvent Red 52, C.I. Solvent Red 58, C.I. Solvent Red 68, C.I. Solvent Red 11, C.I. Solvent Red 122, C.I. Solvent Yellow 19, C.I. Solvent Yellow 44, C.I. Solvent Yellow 77, C.I. Solvent Yellow 79, C.I. Solvent Yellow 81, C.I. Solvent Yellow 82, C.I. Solvent Yellow 93, C.I. Solvent Yellow 98, C.I. Solvent Yellow 103, C.I. Solvent Yellow 104, C.I. Solvent Yellow 112, C.I. Solvent Yellow 162, C.I. Solvent Blue 25, C.I. Solvent Blue 36, C.I. Solvent Blue 69, C.I. Solvent Blue 70, C.I. Solvent Blue 93, and C.I. Solvent Blue 95.

For each color of the toner, the colorants may be used singly or in combination of two or more.

The content of the colorant is preferably from 1 to 10 parts by mass, more preferably from 2 to 8 parts by mass, based on 100 parts by mass of the binder resin.

[Releasing Agent]

The toner particles may contain a releasing agent. In this case, the releasing agent may be, for example, a hydrocarbon wax such as a polyethylene wax, an oxidized polyethylene wax, a polypropylene wax, or an oxidized polypropylene wax, a carnauba wax, a fatty acid ester wax, Sasolwax, a rice wax, a candelilla wax, a jojoba oil wax, a beeswax, or the like.

The content of the releasing agent is generally from 1 to 30 parts by mass, more preferably from 5 to 20 parts by mass, based on 100 parts by mass of the binder resin. When the content of the releasing agent falls within the range, sufficient fixing releasability can be obtained.

[Charge Control Agent]

The toner particles may contain a charge control agent. In this case, the charge control agent may be any of various known compounds.

The content of the charge control agent is generally from 0.1 to 5.0 parts by mass based on 100 parts by mass of the binder resin.

[Average Particle Size of Toner Particles]

Concerning the average particle size, for example, the toner particles according to an embodiment of the present invention preferably has a volume median diameter of 3 to 9 μm, more preferably 3 to 8 μm. For example, when the particles are produced using the emulsion aggregation method described below, the particle size can be controlled by the concentration of the coagulant used, the added amount of the organic solvent, the fusion time, or the composition of the polymer.

When the volume median diameter falls within the range, high transfer efficiency can be achieved, so that higher half-tone-image quality and higher fine-line or dot image quality can be achieved.

The volume median diameter of the toner particles is determined by measurement and calculation using a measurement system including Multisizer 3 (manufactured by Beckman Coulter, Inc.) and a computer system connected thereto and installed with Software V3.51 (data processing software).

More specifically, 0.02 g of the sample (toner particles) is added to 20 mL of a surfactant solution (a surfactant solution obtained by diluting, 10-fold with pure water, a neutral detergent containing, for example, a surfactant for dispersing the toner particles) and mixed together. The mixture is then subjected to ultrasonic dispersion for 1 minute no form a toner particle dispersion. The toner particle dispersion is injected with a pipet into an Isoton II (manufactured by Beckman Coulter, Inc.)-containing beaker placed in a sample stand, until the concentration displayed by the measurement system reaches 8%. When the concentration is set within this range in this system, measured values are reproducible. In the measurement system, the number of particles to be counted is set to 25,000, and the aperture diameter is set to 50 μm. The measurement range of 1 to 30 μm is divided into 256 parts when the frequency value is calculated. The volume median diameter is defined as the particle size at which the volume fraction of larger particles is 50%.

[Average Circularity of Toner Particles]

In view of improvement of transfer efficiency, the toner particles according to an embodiment of the present invention preferably have an average circularity of 0.930 to 1.000, more preferably 0.90 to 0.995.

In an embodiment of the present invention, the average circularity of the toner particles is measured using FPIA-2100 (manufactured by Sysmex Corporation).

More specifically, the sample (toner particles) is mixed with an aqueous solution containing a surfactant and dispersed by ultrasonic dispersion or 1 minute. Using FPIA-2100 (manufactured by Sysmex Corporation) under measurement conditions in HPF (high magnification photographing) mode, the dispersion is photographed at a proper concentration of 3,000 to 10,000 particles in HPF detection number. The circularities of the individual toner particles are then calculated from formula (T) below. The circularities of the individual toner particles are summed and then divided by the number of all the toner particles when the average circularity is calculated.

Circularity=(the length of the circumference of a circle having the same projected area as the particle image)/(the length of the circumference of the projection image of the particle) Formula (T):

[Method for Producing Toner]

The toner according to an embodiment of the present invention is formed by adding at least the joined particles as an external additive to the toner particles. The toner particles may be produced by any known method such as a kneading and grinding method, a suspension polymerization method, an emulsion aggregation method, a dissolving and suspending method, a polyester extension method, or a dispersion polymerization method.

Among them, an emulsion aggregation method is preferably used in view of an increase in image quality, particle size uniformity advantageous for high stabilization of electrostatic charge, shape controllability, and easiness of core-shell structure formation.

The emulsion aggregation method includes mixing a dispersion of binder resin fine particles (hereinafter also referred to as “resin fine particles”), dispersed with a surfactant or a dispersion stabilizer, as needed, with a dispersion of toner particle components such as colorant fine particles, adding a coagulant to the mixture to form aggregates with a desired particle size for the toner, and performing shape control by fusing the resin fine particles after or simultaneously with the aggregation, so that toner particles are obtained.

In this method, the resin fine particles may be composite particles each including two or more layers of resins having different compositions.

The resin fine particles may be produced by, for example, emulsion polymerization, miniemulsion polymerization, phase-transfer emulsification, or a combination of some of them. When an internal additive is added to the resin fine particles, the use of miniemulsion polymerization is particularly preferred.

When an internal additive is added to the toner particles, the resin fine particles may contain the internal additive, or a dispersion of fine particles consisting of the internal additive may be separately prepared, and then the internal additive fine particles and the resin fine particles may be aggregated together.

When the toner particles are formed so as to have a core-shell structure, different types of resin fine particles with different compositions may be added at different times in the process of aggregating the particles.

Using a dry process, the external additive including at least the joined particles is added in the form of a powder to the resulting dried toner particles, so that the toner according to an embodiment of the present invention is obtained.

Any of various known mixing devices such as a Turbula mixer, a Henschel mixer, a nauta mixer, and a V-mixing machine may be used to mix the external additive.

[Developer]

The toner according to an embodiment of the present invention may be used as a magnetic or nonmagnetic one-component developer, or a mixture of the toner according to an embodiment of the present invention and a carrier may be used as a two-component developer.

When the toner is used to form a two-component developer, 2 to 10% by mass of the toner is preferably mixed with the carrier.

The toner and the carrier may be mixed using any mixing device such as a nauta mixer, a double-cone mixer, or a V-mixing machine.

Concerning the average particle size of the carrier, the carrier preferably has a volume median diameter of 10 to 60 μm.

In an embodiment of the present invention, the volume median diameter of the carrier is typically measured with a laser diffraction particle size analyzer (HELOS manufactured by Sympatec GmbH) equipped with a wet disperser.

The carrier to be used is preferably a coated carrier composed of magnetic particles as a core material and a resin with which the surfaces of the particles are coated. Any of various resins may be used to form a coating on the core material. For example, a fluororesin, a fluorine-acrylic resin, a silicone resin, a modified silicone resin, or the like may be used for the toner to be positively charged. In particular, a condensation silicone resin is preferably used for the toner so be positively charged. On the other hand, for example, a styrene acrylic resin, a mixed resin of a styrene acrylic resin and a melamine resin or a resin formed by curing the mixed resin, a silicone resin, a modified silicone resin, an epoxy resin, a polyester resin, a urethane resin, a polyethylene resin, or the like may be used for the toner to be negatively charged. In particular, a mixed resin of a styrene acrylic resin and a melamine resin, a resin formed by curing the mixed resin, and a condensation silicone resin are preferably used.

When the toner according to an embodiment of the present invention is used to form a two-component developer, a charge control agent, an adhesion promoter, a primer treatment agent, a resistance controlling agent, and other materials may also be added as needed to the toner and the carrier to form the two-component developer.

[Image Forming Method]

The toner according to an embodiment of the present invention may be used in a common electrophotographic image forming method.

More specifically, such an image forming method includes a charging step including uniformly charging a photoreceptor; an exposure step including exposing the uniformly charged photoreceptor to light to form an electrostatic latent image; a developing step including developing the electrostatic latent image with the toner according to an embodiment of the present invention; a transfer step including transferring the toner image, obtained by the development, onto an image support such as a paper sheet; and a fixing step including fixing the transferred toner image on the image support by a contact-heating fixation process.

While specific embodiments of the present invention have been described, it will be understood that the above embodiments of the present invention are non-limiting and various modifications may be made thereto.

### EXAMPLES

Hereinafter, specific examples of the present invention will be described. It should be noted that such examples should not be construed as limiting of the present invention.

### Production Example 1 for Toner Matrix Particles

(1) Preparation of Dispersion of Colorant Fine Particles

To 160 parts by mass of ion exchanged water was added 11.5 parts by mass of sodium n-dodecyl sulfate. While the resulting solution was stirred, 24.5 parts by Mass of copper phthalocyanine was gradually added to the solution. Subsequently, using a mixing machine CLEARMIX W-MOTION CLM-0.8 (manufactured by M Technique Co., Ltd.), the mixture was subjected to a dispersion process to form a dispersion of colorant fine particles with a volume median diameter of 126 nm. The dispersion is named a dispersion. [C] of colorant fine particles.

(2) Preparation of Dispersion of Styrene Acrylic Resin Fine Particles

(First Stage Polymerization)

A reaction vessel equipped with a stirrer, a temperature sensor, a temperature controller, a condenser tube, and a nitrogen introducing unit was charged with an anionic surfactant solution previously prepared by dissolving 2.0 parts by mass of an anionic surfactant, sodium laurel sulfate, in 2,900 parts by mass of ion exchanged water. The internal temperature of the vessel was raised to 80° C. with stirring at 230 rpm under a nitrogen stream. To the surfactant solution was added 9.0 parts by mass of a polymerization initiator, potassium persulfate (KPS). After the internal temperature was set to 78° C., a monomer solution (1) including 540 parts by mass of styrene, 270 parts by mass of n-butyl acrylate, 65 parts by mass of methacrylic acid, and 17 parts by mass of n-octyl mercaptan was added dropwise over 3 hours. After she dropwise addition was completed, the mixture was subjected to polymerization (first stage polymerization) by heating and stirring at 78° C. for 1 hour to form a dispersion of resin fine particles (a).

(Second Stage Polymerization: Formation of Intermediate Layer)

In a flask equipped with a stirrer, 51 parts by mass of a paraffin wax (73° C. in melting point) as a releasing agent was added to a monomer solution including 94 parts by mass of styrene, 60 parts by mass of n-butyl acrylate, 11 parts by mass of methacrylic acid, and 5 parts by mass of n-octyl mercaptan. The materials were dissolved by heating at 85° C. to form a monomer solution (2).

Separately, a surfactant solution, which was prepared by dissolving 2 parts by mass of an anionic surfactant, sodium lauryl sulfate, in 1,100 parts by mass of ion exchanged water, was heated to 90° C., and then the dispersion of resin fine particles (a) was added in an amount of 28 parts by mass (based on the solids of the resin particles (a)) to the surfactant solution. Subsequently, using a circulating path-equipped mechanical disperser CLEAR=(manufactured by M Technique Co., Ltd.), the monomer solution (2) was mixed and dispersed in the resulting mixture for 4 hours to form a dispersion containing emulsified particles with a dispersed particle size of 350 nm. To the resulting dispersion was added an aqueous initiator solution prepared by dissolving 2.5 parts by mass of a polymerization initiator KPS in 110 parts by mass of ion exchanged water. The resulting system was subjected to polymerization (second stage polymerization) by heating and stirring at 90° C. for 2 hours to form a dispersion of resin fine particles (b).

(Third Stage Polymerization: Formation of Outer Layer)

To the dispersion of resin particles (b) was added an aqueous initiator solution prepared by dissolving 25 parts by mass of a polymerization initiator KPS in 11.0 parts by mass of ion exchanged water. Under temperature conditions of 80° C., a monomer solution (3) including 210 parts by mass of styrene, 72 parts by mass of n-butyl acrylate, 12 parts by mass of methacrylic acid, and 5.2 parts by mass of n-octyl mercaptan was then added dropwise over 1 hour. After the dropwise addition was completed, the mixture was subjected to polymerization (third stage polymerization) by heating and stirring for 3 hours. The product was then cooled to 28° C. to give a dispersion [1] of styrene acrylic resin fine particles.

(3) Preparation of Toner Matrix Particles

A reaction vessel equipped with a stirrer, a temperature sensor, and a condenser tube was charged with 300 parts by mass (on solid basis) of the dispersion [1] of styrene acrylic resin fine particles and 2,000 parts by mass of ion exchanged water. An aqueous 5 mol/liter sodium hydroxide solution was then added to adjust the pH of the mixture to 10. Subsequently, 40 parts by mass (on solid basis) of the dispersion [C] of colorant fine particles was added to the mixture. An aqueous solution prepared by dissolving 60 parts by mass of magnesium chloride in 60 parts by mass of ion exchanged water was then added over 10 minutes to the mixture at 30° C. under stirring. Subsequently, the mixture was allowed to stand for 3 minutes and then started to be heated. The system was heated over 60 minutes to 80° C. and then kept at 80° C. while the particle growth reaction was continued. In this state, the size of the aggregate particles was measured with Multisizer 3 (manufactured by Beckman Coulter, Inc.). At the time when the volume median diameter (D₅₀) reached 6.5 μm, an aqueous solution prepared by dissolving 190 parts by mass of sodium chloride in 760 parts by mass of ion exchanged water was added to stop the particle growth. The mixture was further raised in temperature and heated and stirred at 90° C. so that the fusion of the particles was allowed to proceed. At the time when the average circularity of the particles measured with a toner average circularity measurement system FPIA-2100 (manufactured by Sysmex Corporation) reached 0.945 (4,000 in HPF detection number), the mixture was cooled to 30° C. to give a dispersion of toner matrix particles.

The dispersion of toner matrix particles was separated into solid and liquid fractions using a centrifuge, so that a wet cake of toner matrix particles was obtained. Using the centrifuge, the wet cake was washed with ion exchanged water at 35° C. until the electric conductivity of the resulting filtrate reached 5 μS/cm. Subsequently, the cake was transferred to Flash Jet Dryer (manufactured by Seishin Enterprise Co., Ltd.) and then dried until the water content reached 0.3% by mass, so that toner matrix particles [1] were obtained.

### Production Examples 2 and 3 for Toner Matrix Particles

A dispersion [2] of styrene acrylic resin fine particles and a dispersion [3] of styrene acrylic resin fine particles were prepared as in Production Example 1 for toner matrix particles, except that the contents of styrene (St), n-butyl acrylate (BA), and methacrylic acid (MMA) in the monomer solution (3) were changed according to Table 1 in the third stage polymerization step of (2) preparation of dispersion of styrene acrylic resin fine particles. Toner matrix particles [2] and [3] were prepared as in Production Example 1, except that the dispersions [2] and [3] of styrene acrylic resin fine particles were each used instead of the dispersion [1] of styrene acrylic resin fine particles in the step of (3) preparation of toner matrix particles.

TABLE 1

| Styrene acrylic | Monomers (parts by mass) | | |
|---|---|---|---|
| resin No. | Styrene | BA | MAA |
| [1] | 210 | 72 | 12 |
| [2] | 197 | 77 | 27 |
| [3] | 231 | 66 | 3 |

### Production Example 4 for Toner Matrix Particles

Toner matrix particles [4] were prepared as in Production Example 1 for toner matrix particles, except that a dispersion [1] of polyester resin fine particles prepared as described below was used instead of the dispersion [1] of styrene acrylic resin fine particles in (3) preparation of toner matrix particles.

Preparation of dispersion of Polyester Resin Fine Particles

(1) Synthesis of Polyester Resin

Three hundred sixty parts by mass of a 2-mole propylene oxide adduct of bisphenol A, 80 parts by mass of terephthalic acid, 55 parts by mass of fumaric acid, and 2 parts by mass of titanium tetraisopropoxide as a polycondensation catalyst were added in 10 parts to a reaction chamber equipped with a condenser tube, a stirrer, and a nitrogen introducing tube. The mixture was allowed to react at 200° C. for 10 hours under a nitrogen stream while the produced water was removed by distillation. The reaction mixture was then allowed to react at a reduced pressure of 13.3 kPa (100 mmHg). At the time when the softening point reached 104° C., the product was taken out, so that a polyester resin was synthesized.

(2) Preparation of Dispersion of Polyester Resin Particles

Using Roundell Mill RM (manufactured by TOKUJU CORPORATION), 100 parts by mass of the resulting polyester resin was ground, and then mixed with 638 parts by mass of a 0.26% by mass sodium lauryl sulfate solution prepared in advance. Under stirring, the mixture was subjected to ultrasonic dispersion for 30 minutes using an ultrasonic homogenizer US-150T (manufactured by NIHONSEIKI KAISHA LTD.) at V-LEVEL and 300 μA, so that a dispersion. [1] of polyester resin fine particles with a volume median diameter (D⁵⁰) of 250 nm was obtained.

### Production Example 5 for Toner Matrix Particles

Toner matrix particles [5] were prepared as in Production Example 1 for toner matrix particles, except that (3) preparation of toner matrix particles was performed as described below.

Preparation of Toner Matrix Particles

A reaction vessel equipped with a stirrer, a temperature sensor, and a condenser tube was charged with 300 parts by mass (on solid basis) of the dispersion [1] of styrene acrylic resin fine particles and 2,000 parts by mass of ion exchanged water. An aqueous 5 mol/liter sodium hydroxide solution was then added to adjust the pH of the mixture to 10. Subsequently, 40 parts by mass (on solid basis) of the dispersion [C] of colorant fine particles was added to the mixture. An aqueous solution prepared by dissolving 60 parts by mass of magnesium chloride in 60 parts by mass of ion exchanged water was then added over 10 minutes to the mixture at 30° C. under stirring. Subsequently, the mixture was allowed to stand for 3 minutes and then started to be heated. The system was heated over 60 minutes to 80° C. and then kept at 80° C. while the particle growth reaction was continued. In this state, the size of the aggregate particles was measured with Multisizer 3 (manufactured by Beckman Coulter, Inc.). At the time when the volume median diameter (D₅₀) reached 6.5 μm, 30 parts by mass (on solid basis) of the dispersion [1] of polyester resin fine particles was added over 30 minutes to the system. At the time when the supernatant of the reaction liquid became clear, an aqueous solution prepared by dissolving 190 parts by mass of sodium chloride in 760 parts by mass of ion exchanged water was added to stop the particle growth. The mixture was further raised in temperature and heated and stirred at 90° C. so that the fusion of the particles was allowed to proceed. At she time when the average circularity of the particles measured with a toner average circularity measurement system FPIA-2100 (manufactured by Sysmex Corporation) reached 0.945 (4,000 in HPF detection number), the mixture was cooled to 30° C. to give a dispersion of toner matrix particles.

The dispersion of toner matrix particles was separated into solid and liquid fractions using a centrifuge, so that a wet cake of toner matrix particles was obtained. Using the centrifuge, the wet cake was washed with ion exchanged water at 35° C. until the electric conductivity of the resulting filtrate reached 5 μS/cm. Subsequently, the cake was transferred to Flash Jet Dryer (manufactured by Seishin Enterprise Co., Ltd.) and then dried until the water content reached 0.5% by mass, so that toner matrix particles [5] were obtained.

### Production Example 6 for Toner Matrix Particles

Toner matrix particles [6] were prepared as in Production Example 1 for toner matrix particles, except that a dispersion [1] of vinyl-modified polyester resin fine particles prepared as described below was used instead of the dispersion [1] of binder resin fine particles in (3) preparation of toner matrix particles.

Preparation of Dispersion of Vinyl-Modified Polyester Resin Fine Particles

(1) Synthesis of Vinyl-Modified Polyester Resin

A 10-liter-volume, four-neck flask equipped with a nitrogen introducing tube, a dewatering tube, a stirrer, and a thermocouple was charged with 480 parts by mass of a 2-mole propylene oxide adduct of bisphenol A, 130 parts by mass of terephthalic acid, 85 parts by mass of fumaric acid, and 2 parts by mass of an esterification catalyst (tin octoate). The mixture was subjected to a polycondensation reaction at 230° C. for 8 hours and then further allowed to react at 8 kPa for 1 hour. After the reaction mixture was cooled to 160° C., a mixture of 8.6 parts by mass of acrylic acid, 131 parts by mass of styrene, 30 parts by mass of butyl acrylate, and 10 parts by mass of a polymerization initiator (di-tert-butyl peroxide) was added dropwise from a dropping funnel to the mixture over 1 hour. After the dropwise addition, an addition reaction of the mixture was continued for 1 hour while the mixture was kept at 160° C. Subsequently, the reaction mixture was heated to 200° C. and kept at 10 kPa for 1 hour. Acrylic acid, styrene, and butyl acrylate were then removed from the reaction mixture, so that a vinyl-modified polyester resin was obtained. The vinyl-modified polyester resin had a glass transition point (Tg) of 60° C., a number average molecular weight of 3,000, and a weight average molecular weight of 18,000.

(2) Preparation of Dispersion of Polyester Resin Particles

Using Roundell Mill RM (manufactured by TOKUJU CORPORATION), 100 parts by mass of the resulting vinyl-modified polyester resin was ground, and then mixed with 638 parts by mass of a 0.26% by mass sodium lauryi sulfate solution prepared in advance. Under stirring, the mixture was subjected to ultrasonic dispersion for 30 minutes using an ultrasonic homogenizer US-150T (manufactured by NIHONSEIKI KAISHA LTD.) at V-LEVEL and 300 μA, so that a dispersion [1] of vinyl-modified polyester resin fine particles with a volume median diameter (D₅₀) of 170 nm was obtained.

Table 2 below shows the acid values of the binder resins used to form she toner matrix particles [1] to [6].

TABLE 2

| Toner matrix | | Acid value |
|---|---|---|
| particles No. | Binder resin | (KOH mg/g) |
| [1] | Styrene acrylic resin [1] | 20 |
| [2] | Styrene acrylic resin [2] | 28 |
| [3] | Styrene acrylic resin [3] | 3 |
| [4] | Polyester resin [1] | 20 |
| [5] | Styrene acrylic resin [1] + | 21 |
| | polyester resin [1] | |
| [6] | Vinyl-modified polyester | 20 |
| | resin [1] | |

### Production Example 1 for External Additive

In an Erlenmeyer flask, 347.4 g of pure water was weighed, to which 102.6 g of tetramethoxysilane was added under stirring. The mixture was stirred as it was for 1 hour to form 450 g of a tetramethyl orthosilicate (TMOS) hydrolysis liquid.

A 3-liter glass reaction vessel equipped with a stirrer, a dropping funnel, and a thermometer was then charged with 2,250 g of water and 36 g (charge-in quantity) of ethylenediamine, and the materials were mixed. While the resulting solution was adjusted to 35° C., the IMPS hydrolysis liquid was added at 2.5 mL/minute to the solution with stirring.

After the addition was completed, the mixture was kept as it was for 30 minutes, and then 4.5 g of an aqueous 1 mmol/g ethylenediamine solution was added to adjust the pH of the mixture to 8 to 9.

Thereafter, the addition of the IMPS hydrolysis liquid at the specific rate was continued at intervals of 3 hours while the alkali catalyst was added as needed to keep the pH at 8.

After the dropwise addition was completed, the stirring was still continued for 0.5 hours to perform the hydrolysis and condensation, so that a dispersion [A] of hydrophilic spherical silica fine particles in a mixed solvent was obtained.

At room temperature, 4 g of methyltrimethoxysilane was added dropwise to the mixed solvent dispersion [A] over 0.5 hours. The mixture was then allowed to react by heating at 50° C. for 1 hour, so that a dispersion. [B] of hydrophobic spherical silica fine particles in a mixed solvent was obtained by making the surface of the silica fine particles hydrophobic.

An ester adapter and a condenser tube were then attached to the glass reaction vessel, in which the mixed sol vent dispersion [B] was heated at 100° C. so that water was removed by distillation. Subsequently, while 0.65 g of methyl isobutyl ketone was added, a mixture of methanol, water, and methyl isobutyl ketone was simultaneously removed by distillation until the dispersion reached 115° C. After 82.5 g of octyltrimethoxysilane was added to the resulting methyl isobutyl ketone dispersion at room temperature, the dispersion was allowed to react for 3 hours by heating at 110° C., so that the silica fine particles in the dispersion were alkylated. The solvent in the dispersion was then removed by distillation under reduced pressure (6.650 Pa) at 80° C., so that 155 g of hydrophobic spherical silica fine particles were obtained. The resulting particles are named an external additive [1].

### Production Examples 2 to 4 for External Additive

External additives [2] to [4] were obtained as in Production Example 1 for external additive, except that the added amount of ethylenediamine and the rate of the addition of the TMOS hydrolysis liquid were changed according to Table 3 below.

TABLE 3

| | | Rate | | | | |
|---|---|---|---|---|---|---|
| | | (mL/min) of | | | | |
| | | addition | | Primary | | |
| External | Added amount (g) | of TMOS | | particle | Secondary | Size |
| additive | of | hydrolysis | | size | particle | ratio |
| No. | ethylenediamine | liquid | Shape | (d1) | size (d2) | (d2/d1) |
| [1] | 36 | 2.5 | Two-sphere | 55 nm | 110 nm | 2.0 |
| | | | shape | | | |
| [2] | 25 | 1.9 | Triangular | 35 nm | 90 nm | 2.6 |
| | | | shape | | | |
| [3] | 49 | 3 | True | 65 nm | 65 nm | 1.0 |
| | | | sphere | | | |
| | | | shape | | | |
| [4] | 20 | 1.3 | Pearl | 20 nm | 110 nm | 5.5 |
| | | | necklace | | | |
| | | | shape | | | |

### Examples 1 to 8 and Comparative Examples 1 and 2

According to the formulation in Table 4, the external additives [1], [2], [3], [4], [5], and [6] were selected and added to the toner matrix particles [1], [2], [3], [4], [5], or [6] and mixed for 20 minutes using a Henschel mixer at a stirring peripheral speed of 40 ms, so that toners [1], [2], [3], [4], [5], [6], [7], [8], [9], and [10] were obtained.

In Table 4, external additives [5] and 61 are as follows.

External additive [5]: hydrophobic silica (HMDS-treated, 72% in hydrophobization degree, 40 nm in number average primary particle size)

External additive [6]: hydrophobic titanium oxide (HMDS-treated, 55% in hydrophobization degree, 20 nm in number average primary particle size)

Table 4 also shows the content of the specific-shape joined particles (a), which corresponds to the total content of the external additives [1] and [2].

[Production of Developer]

Each of the toners [1] to [10] was mixed at a concentration of 7.5% by mass with silicone resin-coated ferrite carrier particles with a volume average particle size of 35 μm, so that each of developers [1] to [10] was obtained.

[Durability Test]

The developers [1] to [10] were each loaded into a commercially available digital color multifunction printer bizhub PRO C6500 (manufactured by Konica Minolta). Using the printer, each developer was subjected to a durability test, in which images of letters were printed with a coverage rate of 5% on 10,000 print. sheets (transfer material: A4 woodfree paper (64 g/m² in basis weight)) in a high-temperature, high-humidity environment (temperature 30° C., relative humidity 80% RH).

(1) Evaluation of Durability Degradation

A 10-cm square solid image was printed before and after the durability test, respectively. The image density of 10 arbitrary points of the solid image was measured with a reflective densitometer RD-918 (manufactured by Macbeth), and the average density was calculated. The average density of the solid image formed before the durability test is represented by W1, and the average density of the solid image formed after the durability test is represented by W2. The range Δ of change in the image density was calculated by subtracting W1 from W2 (W2−W1) and used in the evaluation of the degree of durability degradation. Table 4 shows the results. The case where the range Δ of change in the image density was 0.15 or less was determined to be acceptable according to an embodiment of the present invention.

(2) Evaluation of Environmental Dependence

The density of 20 arbitrary points of a non-printed sheet (white sheet) was measured with a reflective densitometer RD-918 (manufactured by Macbeth), and the average value was used as the white sheet density. On the other hand, after the durability test, the white sheet was subjected to printing. Subsequently, the density of 20 arbitrary white background points of the sheet was measured with the reflective densitometer RD-918 (manufactured by Macbeth), and the average value was calculated. The fogging density was then calculated by subtracting the white sheet density from the average density and used in the evaluation of environmental dependence. Table 4 shows the results. The case where the fogging density was 0.10 or less was determined to be acceptable according to an embodiment of the present invention.

TABLE 4

| | | | External additive | | | | | | | | | | |
|---|---|---|---|---|---|---|---|---|---|---|---|---|---|
| | | | | | | | Small-size | | | | | | |
| | | | Joined particles | | | | particles | | Particles | Evaluation results | | | |
| | | Toner | External | External | External | External | External | External | (a) | Durability | | | |
| | | matrix | additive | additive | additive | additive | additive | additive | content | degra- | | Environmental | |
| | Toner | particles | [1] | [2] | [3] | [4] | [5] | [6] | (% by | radation | | dependence | |
| | No. | No. | Content (% by mass) | | | | | | number) | Rate | Value | Rate | Value |
| Example 1 | [1] | [1] | 0.7 | — | 0.2 | — | 1.5 | 0.6 | 70 | Fair | 0.14 | Good | 0.04 |
| Example 2 | [2] | [2] | 0.7 | — | 0.2 | — | 1.5 | 0.6 | 70 | Good | 0.12 | Fair | 0.07 |
| Example 3 | [3] | [3] | 0.7 | — | 0.2 | — | 1.5 | 0.6 | 70 | Fair | 0.15 | Good | 0.04 |
| Example 4 | [4] | [4] | 0.7 | — | 0.2 | — | 1.5 | 0.6 | 70 | Good | 0.11 | Fair | 0.08 |
| Example 5 | [5] | [5] | 0.7 | — | 0.2 | — | 1.5 | 0.6 | 70 | Good | 0.12 | Fair | 0.09 |
| Example 6 | [6] | [6] | 0.7 | — | 0.2 | — | 1.5 | 0.6 | 70 | Good | 0.11 | Good | 0.06 |
| Example 7 | [7] | [6] | 0.6 | — | — | 0.5 | 1.0 | 0.6 | 92 | Good | 0.11 | Good | 0.05 |
| Example 8 | [8] | [6] | 0.4 | 0.4 | — | 0.7 | 1.5 | 0.6 | 55 | Fair | 0.14 | Good | 0.05 |
| Comparative | [9] | [6] | — | 0.2 | 0.7 | — | 1.5 | 0.6 | 3 | Poor | 0.19 | Fair | 0.1 |
| Example 1 | | | | | | | | | | | | | |
| Comparative | [10] | [6] | — | — | 0.7 | — | 1.5 | 0.6 | 33 | Poor | 0.18 | Poor | 0.13 |
| Example 2 | | | | | | | | | | | | | |

Although the present invention has been described and illustrated in detail, it is clearly understood that the same is by way of illustrated and example only and is not to be taken by way of limitation, the scope of the present invention being interpreted by terms of the appended claims.

What is claimed is:

1. An electrostatic charge image developing toner comprising:
toner matrix particles containing a binder resin; and
an external additive added to the toner matrix particles, wherein
the external additive comprises joined particles each comprising a secondary particle comprising a plurality of spherical primary particles joined together,
the joined particles comprise at least particles with a secondary particle size d2 in the range of 70 nm to 400 nm, and
particles with a ratio d2/d1 in the range of 1.6 to 4.2 make up at least 50% by number of the particles with a secondary particle size d2 in the range of 70 nm to 400 nm, wherein d1 is a diameter of the primary particle in the joined particle, and d2 is the secondary particle size.

2. The electrostatic charge image developing toner according to claim 1, wherein the binder resin has an acid value of 2 KOHmg/g to 30 KOHmg/g.

3. The electrostatic charge image developing toner according to claim 1, wherein the binder resin constituting the toner matrix particles comprises a vinyl resin.

4. The electrostatic charge image developing toner according to claim 3, wherein the binder resin constituting the toner matrix particles comprises a vinyl resin and a polyester resin.

5. The electrostatic charge image developing toner according to claim 1, wherein the binder resin constituting the toner matrix particles comprises a vinyl-modified polyester resin comprising a vinyl polymer segment and a polyester segment bonded together.

6. The electrostatic charge image developing toner according to claim 1, wherein the joined particles comprise particles having a secondary particle size d2 in the range of 70 nm to 400 nm and a ratio d2/d1 of secondary particle size d2 to primary particle diameter d1 in the range of 1.6 to 4.2, wherein the primary particle diameter d1 is in the range of 30 nm to 200 nm.

7. The electrostatic charge image developing toner according to claim 1, wherein the joined particles are silica particles obtained by sol-gel method.
